(19) United States
(12) Patent Application Publication
(10) Pub. No.: US 2007/0145748 A1
(43) Pub. Date: Jun. 28, 2007

(54) Power generation system

(75) Inventor: Stephen J. Pierz, Peoria, IL (US)

Correspondence Address: Caterpillar Inc.;Intellectual Property Dept., AB 6490, 100 N.E. Adams Street, PEORIA, IL, 61629-6490, US

(73) Assignee: Caterpillar Inc.

(21) Appl. No.: 11/642,208

(22) Filed: Dec. 20, 2006

Related U.S. Application Data
(60) Provisional application No. 60/753,508, filed on Dec. 23, 2005.

(51) Int. Cl. F03B 13/00; F03B 13/10; H02P 9/04

(52) U.S. Cl. 290/43

(57) ABSTRACT

A power generation system is provided. The power generation system has a wind turbine, an electrolysis unit, a tank, and a pump. The wind turbine has a base and is mounted to the floor of a body of water. The electrolysis unit is attached to the base and electrically powered by the wind turbine. The electrolysis unit also has a hydrogen gas outlet. The tank is coupled to the outlet, and the pump is coupled to the outlet and the tank.

### CLAIM FOR PRIORITY

The present application claims priority from U.S. Provisional Application Ser. No. 60/753,508, filed Dec. 23, 2005, which is fully incorporated herein.

### TECHNICAL FIELD

This invention relates generally to a power generation system. More particularly, the invention relates to a system for a producing hydrogen and oxygen using wind turbines at sea and for delivering the hydrogen and oxygen using a pump.

### BACKGROUND

As the world's supply of fossil fuels is depleted, there is a growing need for non-polluting renewable energy sources. One renewable energy source that is being harnessed is wind energy. Wind energy is used to drive wind turbines to produce electricity. In order to generate sufficient power, large numbers of wind turbines are arranged in arrays known as wind farms. To avoid nuisance issues, preserve valuable land, and increase power, some of these farms are located at sea.

Because the energy available from wind is variable, and the demand for the electricity produced is variable, wind turbines have been used to convert their output to hydrogen, which is more easily stored. One example of such a system is disclosed in U.S. Pat. No. 6,918,350 to Morse (“Morse”). Morse discloses a sea-based hydrogen and oxygen generation system using floating collection vessels located at sea. In Morse, a wind turbine is mounted to a moveable collection vessel. The electricity from the wind turbine is used to electrolyze water to produce hydrogen and oxygen gas. These gases are then temporarily stored in bottles, and then transported by another collection vessel to shore.

Although the system disclosed in Morse may use wind energy to produce hydrogen and oxygen, it requires a ship to transport the hydrogen and oxygen to shore. In addition, there are potential safety risks associated with handling vessels at sea loaded with hydrogen. Moreover, the supply of produced hydrogen and oxygen is intermittent.

The present invention is directed to overcome one or more of the problems as set forth above.

### SUMMARY OF THE INVENTION

In one aspect of the present invention, a power generation system is provided. The power generation system has a wind turbine, an electrolysis unit, a tank, and a pump. The wind turbine has a base and is mounted to the floor of a body of water. The electrolysis unit is attached to the base and electrically powered by the wind turbine. The electrolysis unit also has a hydrogen gas outlet. The tank is coupled to the outlet, and the pump is coupled to the outlet and the tank.

In another aspect of the present invention, a method of generating power is disclosed. The method includes the steps of providing a wind turbine having a base, and mounting the base to the floor of a body of water. The method also includes the steps of attaching an electrolysis unit to the base and electrically powering the electrolysis unit from the wind turbine. The method also includes the step of producing hydrogen gas from the electrolysis unit. The method also includes pumping the hydrogen gas to a tank.

In a third aspect of the present invention, a system for generating power includes a wind turbine, an electrolysis unit, and means for pumping hydrogen gas. The wind turbine is mounted to the floor of a body of water. The electrolysis unit is attached to the base and powered by the wind turbine. The electrolysis unit is also configured to produce hydrogen gas, which is pumped to a tank by the means for pumping the hydrogen gas.

### BRIEF DESCRIPTION OF THE DRAWINGS

FIG. 1 is a diagrammatic illustration of a power generation system suitable for use with the present invention;

### DETAILED DESCRIPTION

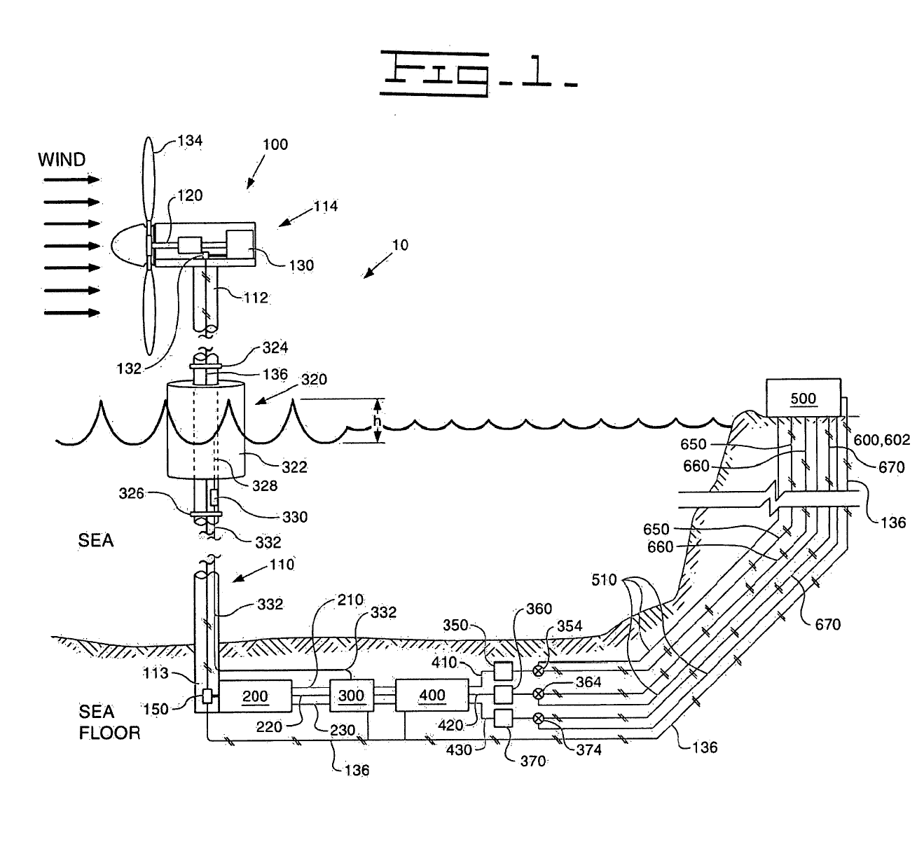

A power generation system 10 for producing and delivering hydrogen and oxygen produced at sea in accordance with the present invention is illustrated in FIG. 1. As shown, the system 10 includes a wind turbine 100, an electrolysis unit 200, a pump 300, and storage tanks 350, 360, 370. The system 100 may also include a liquefier unit 400. The system 100 is preferably located at sea, although it may also be situated in other large bodies of water, such as lakes, rivers, etc.

The wind turbine 100 includes a base 110 securely mounted in the sea floor. The base 110 extends above the surface of the water, and terminates in a turbine head 114. The turbine head 114 includes a main rotor shaft 120 and generator 130 and is mounted at the top 112 of the base 110. As shown in FIG. 1, the main rotor shaft 120 is mounted horizontally, although other configurations may also be used. For example, a vertical axis turbine, with the main rotor shaft running vertically, may also be used. One end of the main rotor shaft 120 rotates within a stator 132. The other end of rotor shaft 120 is attached to at least one blade 134. One exemplary embodiment uses three blades 134, although fewer or greater numbers may also be used. The stator 132 is electrically connected to the generator 130, with the wind turbine 100 producing alternating current (AC) power as the blades 134 are rotated by the wind. Generator 130 may include circuitry (not shown) to convert the variable frequency AC to direct current (DC) and then back to AC to provide an optimum line frequency and voltage for the electrolysis unit 200. A gear box (not shown), which would turn the slower rotation of blades 134 into a quicker speed better suited for the production of electricity, may also be inserted between the rotor 120 and the generator 130, so that the generator 130 cost and weight can be reduced. The wind turbine 110 may also use a wind sensor (not shown) coupled with a servomotor (not shown) to point the turbine head 114 into the direction of the wind.

The electrical lines 136 extend down from the generator 130 to the bottom 113 of the base 110. From there, they extend into an AC/DC converter 150. The AC/DC converter 150 is then electrically connected to the electrolysis unit 200. The electrolysis unit 200 is located at the sea floor, and may be integrally housed at the base 113 of the base of the turbine 110 or packaged as a separate unit. The electrolysis unit 200 uses the DC current supplied from the AC/DC converter 150 to electrolyze sea water into hydrogen and oxygen gas, according to the following formula:
2H₂O(l)→2H₂(g)+O₂(g)
By locating the electrolysis unit 200 at the sea floor, the pressure from the weight of the water increases the efficiency of the electrolysis process, and allows for cooler, more compressed hydrogen and oxygen gas.

The hydrogen produced from the electrolysis unit 200 is pumped through a conduit 210 by the pump 300 into a hydrogen storage tank 350. Similarly, the oxygen produced by the electrolysis unit 200 is pumped through a conduit 220 by the pump 300 into an oxygen storage tank 360. The remaining byproduct of the electrolysis process, a slurry solution of salt and other minerals, may also be pumped through a conduit 230 into a storage tank 370 by the pump 300, or directly into the sea.

The pump 300 may compress the hydrogen and oxygen gas in conduits 210, 220, into tanks 350, 360, respectively. The pump 300 may also pump the slurry solution into the storage tank 370. The pump 300 is configured to withstand the pressure from the weight of the water to the surface. The pump 300 may be electrically powered from the electricity produced from the wind turbine 100. Alternately, separate pumps for each conduit 210, 220, and 230 may be used in place of the pump 300.

In addition, the pump 300 may be powered from a wave pump 320. The wave pump 320 includes a buoyant float 322 mounted on the base 110 of the wind turbine 100. The float 322 rises and falls with the naturally occurring undulations of the ocean height, shown as “h”, due to the tides, wind, undersea earth activity, etc. The float 322 may be donut-shaped, such that it is mounted around the base 110. An upper stop 324 and a lower stop 326 may also be mounted on the base of the wind turbine to restrict the maximum amplitude of the float 322 during rough seas, storms, etc. A mechanical linkage 328 may be coupled to a pump drive mechanism 330 located within the base 110 of the wind turbine 100. The pump drive mechanism 330 may be mechanically coupled to drive the pump 300. Alternately, the pump drive mechanism may pump compressed air or water through a line 332 to drive the pump 300. One example of a mechanically actuated pump is disclosed in U.S. Patent Application 2004/0071566 to Hill, the contents of which are hereby incorporated by reference.

The liquefier unit 400 may be added to the system 10 and positioned either upstream or downstream of the pump 300 to provide for liquid hydrogen and oxygen. The liquefier unit uses the cool temperatures of the sea floor to provide for initial refrigeration, and may also exhaust waste heat from the compressed hydrogen and oxygen gas into the sea. It may be powered from electricity produced by the wind turbine 100. As shown in FIG. 1, a hydrogen conduit 410 and an oxygen conduit 420 extends from the pump 300 to the storage tanks 350, 360, respectively.

The hydrogen storage tank 350, the oxygen storage tank 360, and the slurry storage tank 370 may each include pressure sensors (not shown) to detect when the tanks 350, 360, 370 reach a desired pressure. A control module 500 may receive the data from the sensors and may be positioned at the shore 600, at an off-shore platform 602, or at the sea floor. Through a control line 510, the control module 500 may actuate electronic valves 354, 364, 374 on each of the tanks 350, 360, 370 to allow the hydrogen, oxygen, and slurry to be pumped to shore 600 or an off-shore platform 602 through pipes 650, 660, 670, respectively.

One alternate embodiment of the present invention may use multiple turbines 100 to power the electrolysis unit 200. Alternately, one turbine 100 may power the electrolysis unit 200, while another turbine 100 powers the pump 300 and/or the liquefier unit 400. A series of wave-pumps 320 may also extend along conduits 650, 660, 670, to convey the hydrogen, oxygen, and slurry to shore 600 or an off-shore platform 602. Moreover, the turbine 100 may also have electrical lines 700 that extend to shore 600, such that the system 100 produces both electricity and the electrolysis products of hydrogen, oxygen, and slurry. The electricity may be used during times of peak usage, while electrolysis may generate and store hydrogen and oxygen gas during off-peak times.

### INDUSTRIAL APPLICABILITY

In operation, wind causes the blades 134 of the wind turbine 100 to rotate the rotor shaft 10. The rotor shaft 120 rotates within a stator 132, producing electricity through generator 130. The electricity, produced as alternating current, travels through the electrical lines 136 down the base 110 of the wind turbine 100 to an AC/DC converter 150. The electrolysis unit 200 uses sea water and the DC from the AC/DC converter 150 to produce hydrogen and oxygen gas, with the slurry as a byproduct.

The hydrogen and oxygen gas produced by the electrolysis unit 200 is pumped through conduits 210, 220 into storage tanks 350, 360, respectively, by the pump 300. The pump 300 may also pump the slurry to the storage tank 370. The pump may be electrically powered by the wind turbine 100. In addition, the pump may also use the wave pump 320 to further compress the hydrogen and oxygen. The float 322 bobs up and down due to the natural undulations of the sea. This up and down movement is converted to mechanical energy through the mechanical linkage 328 coupled to the pump drive mechanism 330. The pump drive mechanism 330 may compress air or pump water to drive the pump 300. An optional liquefier unit 400 may liquefy the hydrogen and oxygen gas before they reach their respective storage tanks 350, 360. The control unit 500 may automate the flow of hydrogen, oxygen, and slurry through the valves 352, 362, and 372.

The system 10 combines wind power and hydrogen power. In periods when there is surplus wind energy, the excess power may be used for generating hydrogen by electrolysis. The hydrogen is stored, and is pumped to shore. In addition, system 10 uses the depth of the ocean to both cool the hydrogen and oxygen and to pressurize the gases. The hydrogen produced by system 10 may be used in a fuel cell to replace the use of fossil fuels and internal combustion engines. The oxygen produced by system 10 may be burned, used in steel production, etc. The slurry produced as a byproduct in the electrolysis unit 200 may be pumped back to shore 600 to capture the minerals available.

Other aspects, objects and advantages of this invention can be obtained from a study of the drawings, the disclosure, and the appended claims.

What is claimed is:

1. A power generation system comprising:
a wind turbine having a base mounted to the floor of a body of water;
an electrolysis unit attached to the base and electrically powered by the wind turbine, the electrolysis unit having a hydrogen gas outlet;
a tank coupled to the outlet; and
a pump coupled to the outlet and the tank.

2. The power generation system of claim 1 further comprising:
a float mounted to the base at sea level;
a linkage couple to the float; and
a pump drive mechanism coupled to the linkage and driving the pump.

3. The power generation system of claim 1, wherein the pump has a float mounted to the base and a drive mechanism coupled to the float, the drive mechanism operative to drive the pump.

4. The power generation system of claim 3, wherein the pump is electrically powered by the wind turbine.

5. The power generation system of claim 1, further comprising a liquefier unit fluidically coupled with the pump and the tank.

6. A method of generating power, including the steps of:
providing a wind turbine having a base;
mounting the base to the floor of a body of water;
attaching an electrolysis unit to the base;
electrically powering the electrolysis unit with the wind turbine;
producing hydrogen gas from the electrolysis unit; and
pumping the hydrogen gas to a tank.

7. The method of claim 6, further comprising the steps of:
mounting a float to the base at sea level, wherein the float reciprocates up and down;
coupling a linkage to the float; and
driving the pump with the linkage.

8. The method of claim 7, further comprising the step of:
electrically powering the pump with the wind turbine.

9. The method of claim 6, further comprising the step of:
liquefying the hydrogen gas.

10. A system for generating power comprising:
a wind turbine having a base mounted to the floor of a body of water;
an electrolysis unit attached to the base and powered by the wind turbine, the electrolysis unit configured to produce hydrogen gas; and
means for pumping the hydrogen gas to a tank.
